(19) United States
(12) Patent Application Publication
(10) Pub. No.: US 2016/0241006 A1
(43) Pub. Date: Aug. 18, 2016

(54) BUOYANT ELECTRIC ROPE WITH BUBBLER

(71) Applicant: Angler's-Friend, LLC, Merriam, KS (US)

(72) Inventors: Corben David Tannahill, Merriam, KS (US); David Bruce Tannahill, Merriam, KS (US)

(21) Appl. No.: 15/045,525

(22) Filed: Feb. 17, 2016

Related U.S. Application Data
(60) Provisional application No. 62/117,187, filed on Feb. 17, 2015.

(51) Int. Cl. H02G 3/04; F21V 33/00; F16L 11/00; H02G 9/00; B63B 22/00; B63B 45/02

(52) U.S. Cl. CPC H02G 3/04; B63B 22/00; B63B 45/02; F16L 11/00; H02G 9/00; F21V 33/00; F21Y 2101/02

(57) ABSTRACT

A buoyant electric rope configured for transmitting an electric current and/or a gas in water is provided. The rope can include an inner core having an electrically-conductive wire and an air supply tube, and an outer core wrapped around the inner core for protecting the inner core. The outer core can include a coating for protecting and insulating the inner core. Along various locations of the rope, the inner core can have extensions extending outward through openings in the outer core to allow various devices, including lighting devices to be connected to the rope. The extensions can also allow the air supply tube to be connected to various devices and/or release bubbles in the water. The buoyant characteristics of the rope can be created by the materials used to construct the rope, air or liquid in the tube, and/or weights or buoys connected to the rope.

### CROSS-REFERENCE TO RELATED APPLICATIONS

This Application claims priority to U.S. Provisional Patent Application Ser. No. 62/117,187, filed on Feb. 17, 2015, to Corben D. Tannahill et al., entitled “Buoyant Electric Rope with Bubbler,” currently pending, the entire disclosure of which is incorporated herein by reference.

### FIELD OF THE INVENTION

The present invention relates generally to a buoyant rope containing a conductive wire for electrical devices in water. The present invention also relates generally to a buoyant electric rope containing an air tube for influencing buoyancy and releasing air bubbles in the water. The present invention may additionally be easily adapted for various other suitable uses.

### BACKGROUND OF THE INVENTION

Currently, designs for electric wiring or ropes configured for connecting fishing lights in water utilize an insulating plastic sheathing or casing that lacks durability for fishing conditions, buoyancy for sufficient floatation in the water, and mechanical strength for dislodging devices that become entangled during retrieval from the water. Such ropes also generally do not permit the use of several electrical lighting devices at one time. Other designs for electrified ropes not related to fishing lights tend to focus on maximizing strength or providing an electric charge and are not suitable for use in water. Additionally, many designs for electrified ropes currently known commonly use a polyurethane resin coating, which is not generally conducive to buoyance, and are not designed with the intention of having buoyant properties.

Another deficiency of these electrified, water-adapted ropes is that it is often desirable to create air bubbles within the water, whether for attracting fish or other various reasons. However, current electrical ropes for use in water are not adapted for housing an air tube for releasing air bubbles in the water.

Thus, a need exists for a rope having an electric conductor that is suitable for use in water and has buoyant properties. A need also exists for a buoyant electric rope that contains an air tube for creating air bubbles in the water. A need also exist for a buoyant electric rope containing an air tube that is durable and capable of being used with several low voltage electrical devices within water.

### SUMMARY OF THE INVENTION

The present invention is generally directed to a rope having one or more properties, including electric conductivity, buoyancy, pliability and mechanical strength. According to one embodiment of the present invention, a rope configured for both electric conductivity and buoyancy in water is disclosed. The rope can comprise an inner core and an outer core surrounding the outer core. The outer core can include one or more braided rope strands wrapped around the inner core and a coating applied to the exterior of the braided rope strands. The inner core can comprise an electrically conductive wire with and a sheathing protecting the conductive wire. At one or more selective locations along the length of the rope, the outer core can include an opening configured to allowing an extension of the inner core to extend outside the outer core. These extensions can be configured for connecting various electrically-operated devices, such as lighting devices.

In order to provide buoyant properties for the rope, the components used in the construction of the rope can include materials that give the rope a cumulative specific gravity approximately less than the specific gravity of water. As a result, the rope can float on the surface of the water or float at a particular depth below the surface of the water.

According to another embodiment of the present invention, the rope can also be configured with an air supply tube that can be configured for moving air or gas through the rope. The air supply tube can be included within the inner core of the rope and comprise a hollow flexible tube. Similar to the extensions of the conductive wire, the air supply tube can have one or more extensions extending through openings in the outer core at various locations along the length of the rope. The extensions can be used to supply air or gas to various devices or to release the air or gas into the water.

Other aspects and advantages of the present invention will be apparent from the following detailed description of the preferred embodiments and the accompanying drawing figures.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a perspective view of a buoyant electric rope with a bubbler tube in accordance with one embodiment of the present invention;

FIG. 2 is a section view of the buoyant electric rope of FIG. 1, taken generally about line 2-2 in the direction of the arrows, illustrating a braided rope outer core and two conductors in accordance with one embodiment of the present invention;

FIG. 3 is a section view of the buoyant electric rope of FIG. 1, taken generally about line 3-3 in the direction of the arrows, illustrating a braided rope outer core with an air tube and two conductors in accordance with one embodiment of the present invention;

FIG. 4 is a section view of the buoyant electric rope of FIG. 1, taken generally about line 4-4 in the direction of the arrows, illustrating a braided rope outer core having an air tube and two conductors and a coating in accordance with one embodiment of the present invention;

FIG. 5 is a perspective view of a buoyant electric rope having and air tube bubbler and a flexible LED lighting strip in accordance with one embodiment of the present invention;

FIG. 6 is a perspective view of a buoyant electric rope with an electric extension in accordance with one embodiment of the present invention;

FIG. 7 is a perspective view of a buoyant electric rope with several electric extensions and several air tube extensions and schematically illustrating the rope connected to various devices in accordance with one embodiment of the present invention;

FIG. 8 is a perspective view of a buoyant electric rope with weights and buoys schematically attached thereto in accordance with one embodiment of the present invention; and

FIG. 9 is a perspective view of an electric rope having a support cable and electrical wire within the inner core of the rope in accordance with one embodiment of the present invention.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

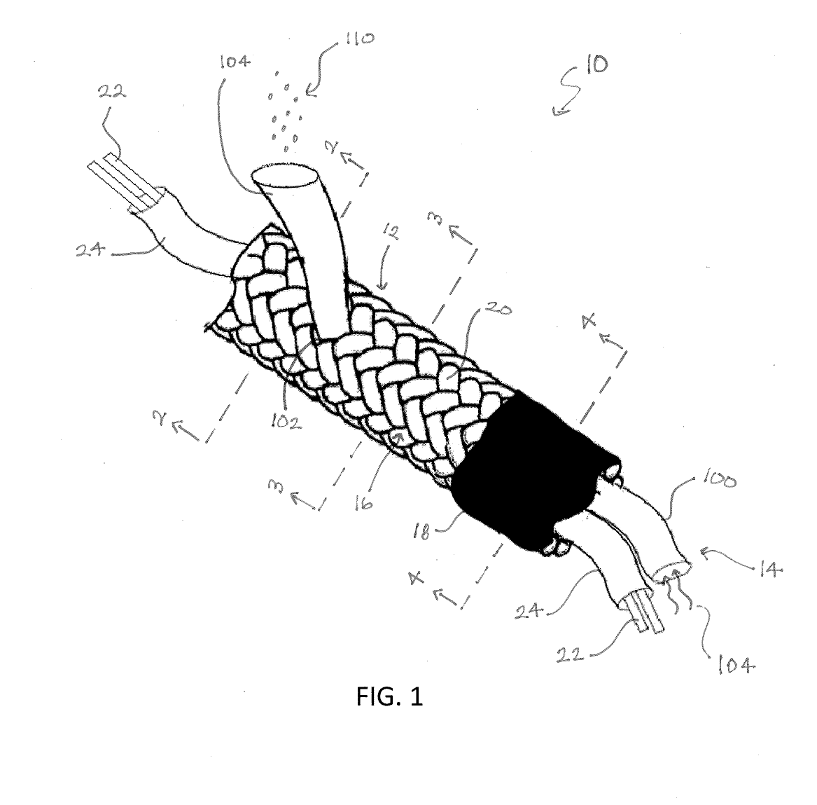

The present invention is directed generally to a buoyant electric rope 10 that can include an air supply tube 100 as illustrated in FIG. 1, according to one embodiment of the present invention. Air supply tube 100 can be used to release air bubbles into the water in which buoyant electric rope 10 is located. Air supply tube 100 can also be used to adjust the buoyancy of rope 10 by retaining a selective combination of gas and/or liquid within air supply tube 100. In other embodiments, electric rope 10 can be designed for uses where the buoyant properties are not particularly relevant, as described in greater detail below.

Buoyant electric rope 10 can be adapted for water use and can be adapted for having buoyant characteristics that can enable rope 10 to float upon the surface of the water or suspend at a particular depth in the water. A buoyant rope solution generally requires the rope structure have a specific gravity equal to or less than the specific gravity of the water in which it resides, or otherwise the rope will sink. The specific gravity of water is generally considered to be about 1.0, depending on the exact chemical makeup of the water. In addition to the rope construction, any coating can be applied to the rope construction so long as the specific gravity of the coating material does not raise the overall specific gravity of the rope to the specific gravity of the water (approximately 1.0 generally), at least at the desired depth.

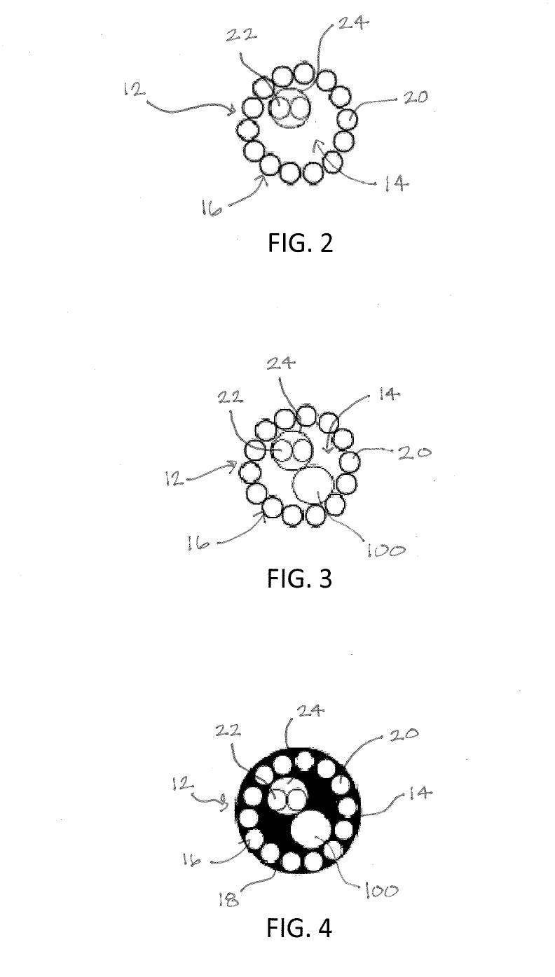

As shown in FIG. 1, buoyant electric rope 10 can include an outer core 12 and an inner core 14. According to one embodiment, outer core 12 can comprise a hollow braided rope 16 and a coating 18 applied thereto; however, outer core 12 can also suitably be constructed with outer structure 16 and no coating 18 in other embodiments. Outer core 12 can also include a generally circular and hollow cross-section, as shown in FIGS. 2-4, according to one embodiment. Many other shapes and configurations for outer core 12 can also be used when constructing rope 10.

Hollow braided rope 16 can be constructed from one or more rope strands, and according to one embodiment, constructed from a plurality of individual rope strands 20, as shown in the figures. Rope strands 20 can be made from one or more of several different suitable materials. According to one embodiment, rope strands 20 can be constructed from polypropylene and/or polyethylene, which can be especially suitable materials due to their relatively low specific gravities (less than 1.0) and water-proof characteristics. Alternatively, several other materials could be used to make hollow braided rope 16, such as polyolefin, or any other suitable plastic or rubber material having a specific density approximately less than 1.0 in order to facilitate the buoyant properties of rope 10. The inclusion of the air supply 100 within rope 10 can also allow outer core 12 and hollow braided rope 16 to be constructed from materials having a specific density approximately greater than 1.0, while still maintaining the rope's 10 buoyant properties; as explained in greater detail below.

As described above, coating 18 can be applied to the exterior of hollow braided rope 16, according to one embodiment of the present invention. Coating 18 can be used to impede or prohibit water and other liquids from penetrating through hollow braided rope 16 and can also increase the strength and durability of outer core 12. Coating 18 can be applied in a manner where it can fill and block the pores within rope 16 and/or the small voids between individual rope strands 20. Coating 18 can be formed from several different suitable materials. Coating 18 can be formed from a polymer or rubberized material that includes microscopic or macroscopic pores, air pockets, bubbles or other void spaces, according to certain embodiments of the present invention. Any type of water-resistant material can also be used for coating 18. In preferred embodiments, the material used for coating 18 has a low specific gravity so as to keep the specific gravity of rope 10 approximately equal to or less than 1; however other materials used in the construction of rope 10 can allow for heavier coating materials in other embodiments.

Inner core 14 of buoyant electric rope 10 can include at least one conductive wire 22 and an insulating sheath or layer 24 as shown in FIG. 1. Conductive wire 22 and insulating layer 24 can form a standard insulated electrical wire, the construction of which is commonly known to those skilled in the art. Conductive wire 22 can comprise any type of electrically conductive wire or cable suitable for conducting an electrical current for service electrical devices. Conductive wire 22 can also consist of a single wire or strands of wires depending on the particular embodiment of the present invention. Insulating layer 24 can be applied so as to encapsulate or cover conductive wire 22 as illustrated in FIGS. 2-4. Insulating layer 24 can be made from any number of materials commonly used to insulate electric conducting wires, including various plastic materials. Insulating layer 24 can also be made from a material that is water-resistant according to several embodiments of the present invention.

In addition to, or alternatively to, conductive wire 22, inner core 14 can include air supply tube 100 that can be adapted for moving an air or gas 106 through rope 10. Tube 100 can have a circular cross-section according to one embodiment, or may have any suitable shape that permits tube 100 to fit within inner core 14. Tube 100 can also be made from any number of different suitable materials, depending on the particular embodiment, including but not limited to polyurethane, polypropylene, polyethylene, and polyolefin. Polyurethane, polypropylene and polyethylene may allow air tube 100 to be sufficiently flexible. Other types of materials such a plastics or rubber may also be used. Preferably, tube 100 can be made from a material that has a specific density near 1.0 so as to maintain the buoyant properties of rope 10. For example, polyurethane common has a specific gravity of about 1.14.

Air tube 100 can be specifically suited for permitting the flow of, air, or other gas 106, through rope 10 as illustrated in FIG. 1. Air tube 100 can be connected to a pump or similar device 108 in order to supply the flow of air through tube 100. Other methods for supplying air 104 through the tube 100 may also be used. The air 106 passing through air tube 100 can be used to release air bubbles 110 into the water as described in greater detail below. In alternative embodiments, air tube 100 can be specifically suited for permitting the flow of liquids, such as water, oil, or other fluids.

Air supply tube 100 can also be used to selectively adjust the buoyancy of rope 10 by altering the level of liquid or gas 106 located in tube 100. According to one embodiment, air supply tube 100 can be suitable for holding a fixed amount of air or gas 106 within tube 100. The amount of air or gas 106 can be selectively adjustable by a user of rope 10. In one embodiment, tube 100 can be partially filled with a liquid, such as water, that increases the specific density of the rope 10. Air or gas 106 can then be selectively added to tube 100, forcing out of tube 100 a selective amount of liquid, in order to decrease the specific density of rope 10 by replacing the liquid with a lower density gas 106. As a result, air supply tube 100 can be used to adjust the buoyancy of rope 10. A user seeking to have rope 10 float on the surface of the water may increase the amount of air 106 within tube 100, giving rope 10 a specific density less than the specific density of the water at the surface. Alternatively, a user seeking to have rope 10 maintain a certain depth beneath the surface of the water may reduce the amount of air 106 in tube 100 and/or increase the amount of water in tube 100, giving rope 10 a specific density similar to the specific density of the water at that particular depth below the surface. Using air supply tube 100 to adjust the specific density of rope 10 may also allow outer core 12 of rope 10 to be constructed from a wider range of materials, including those having a specific density greater than 1.0, while still maintaining buoyant properties within rope 10.

As shown in FIGS. 1-4, inner core 14 can be located inside outer core 12 so that outer core 12 can partially or completely surround inner core 14. Outer core 12 can provide not only the buoyant properties for rope 10 but can also insulate and protect inner core 14.

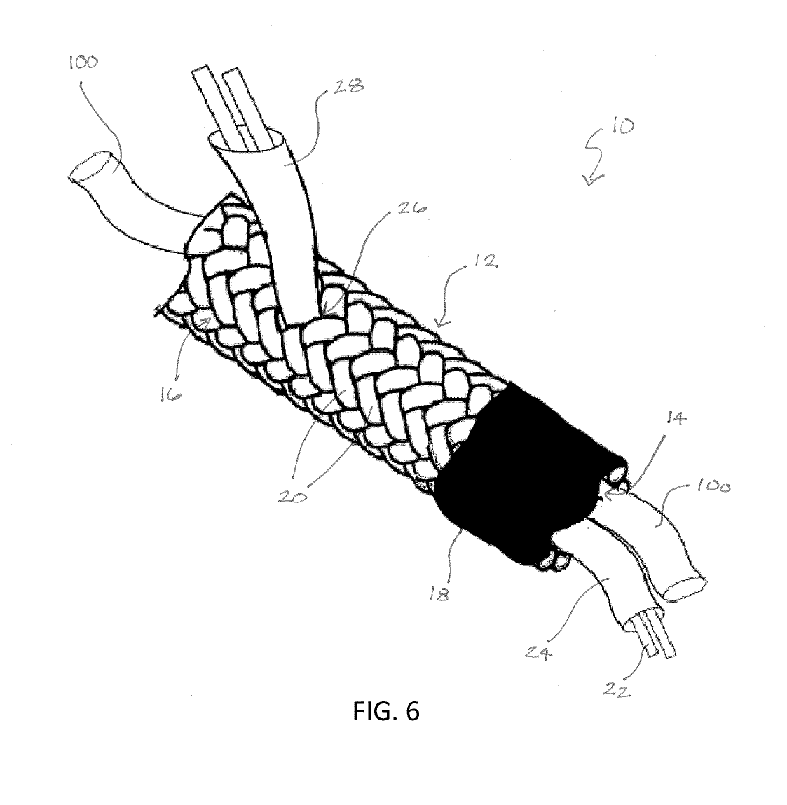

Outer core 12 can also include openings 102 at various locations along the length of buoyant electric rope 10 in order to allow air tube extensions 104 from the inner core 14 to pass through and exit outer core 12, as best shown in FIG. 1. Air tube extensions 104 can be connected to air tube 100 housed within inner core 14. These extensions 104 can be used to release air bubbles 110 into the water or supply air to various devices, such as an aerator device or other device as shown in FIG. 6. Openings 102 can be created in the hollow braided rope 16 between the braids of individual rope strands 20. Extension 104 can then pass through hollow braided rope 16. Openings 102 can also penetrate through coating 18. In one embodiment, openings 102 are formed in outer core 12 and extensions 104 of inner core 14 are placed through openings 102 before coating 18 is applied to hollow braided rope 16. This may provide for better coverage of coating 18. Similar openings 26 and extensions 28 can be used to supply electricity to external devices from conductive wire 22 located within inner core 14 of rope 10 as best shown in FIG. 6.

When buoyant rope 10 is used for marine activities such as fishing, fish attracting lights 30 can be connected to the protruding electrical extensions 28. Air tube extensions 104 can then be used to in conjunction with lights 30 to release air bubbles in the general area of lights 30 to attract fish to a specific location. Additionally, temperature sensors 112 can be used in connection with buoyant rope 10 in order to determine the temperature of different areas of the particular body of water.

In one embodiment of the present invention, lights 30 can be configured as a flexible

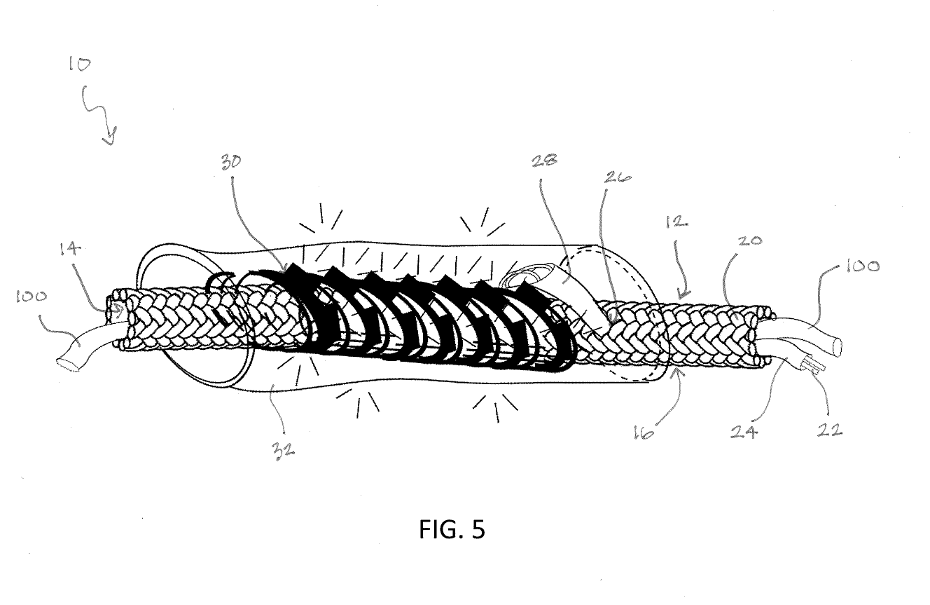

LED light strip 30 that is connected to one of extensions 28 and wrapped around outer core 12 of buoyant electric rope 10, as best shown in FIG. 5. The LED light strip 30 can be used to illuminate buoyant electric rope 10. A clear cylindrical tubing 32 can also be applied around buoyant electric rope 10 in the area where LED light strip 30 is wrapped, as shown in FIG. 5, to assist in protecting and securing light strip 30. In one embodiment, LED light strip 30 is constructed in accordance with the teachings of U.S. Provisional Patent Application No. 62/062,252, filed on Oct. 10, 2014, to Corben D. Tannahill et al., entitled “Spiral Wrap LED Lighting System,” the entire disclosure of which is incorporated herein by reference. Air tube extensions 104 can then be situated near LED light strip 30 to release air bubbles near the lighted area.

In one non-limiting example, the present invention may comprise: (a) a hollow braided rope 16 constructed of a polypropylene material and having an outside diameter (OD) of about ⅜″, (b) a hollow air tube 100 constructed of polyurethane having an OD of about ⅛″ and passing through the interior of rope 16, (c) a two-conductor shielded wire 22 or cable of about 18 gauge having an insulting layer 24 therearound with an OD of about ⅛″ and passing through an interior of rope 16, (d) a coating 18 at least partially surrounding rope 16, (e) an LED light strip 30 spirally wrapped around at least a portion of coated rope 16, and (f) a clear, flexible, ether-cured polyurethane tubing 32 having an inside diameter of about ⅞″ and an outside diameter of about 1⅛″ surrounding at least a portion of light strip 30.

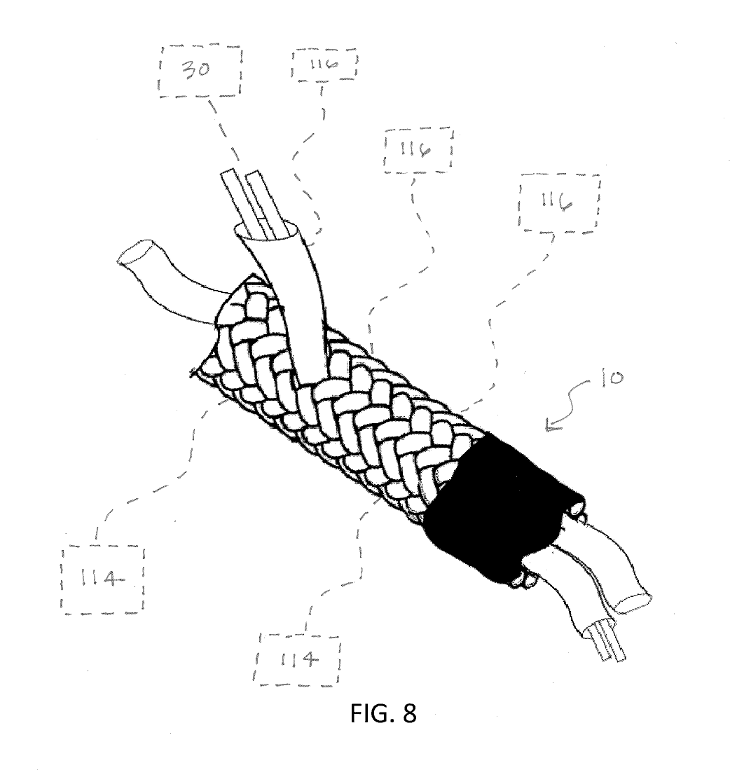

Buoyant electric rope 10 can be designed not only to float on top of the water surface but also at particular depths in the water according to certain embodiments of the present invention. This can be accomplished by selectively using particular materials in the construction of electric rope 10. As described above, the addition of air supply tube 100 within rope 10 can allow for denser materials to be used in the construction of rope 10 while still maintaining its buoyant properties. The buoyancy of rope 10 can also be affected by the use of weights 114 and buoys 116 as illustrated in FIG. 8. Weights 114 can optionally be applied to various portions or sections of rope 10 to cause part of rope 10 to have diminished buoyancy. Weights 114 can be attached to outer core 12 of rope 10, located within inner core 14, located at any portion along extensions 28 and 104, or positioned at any other suitable location on rope 10. In one embodiment, weights 114 are attached to particular extensions 104 protruding out from inner core 14. This can allow various air bubbles 110 to be released at various depths beneath the water surface. In one embodiment, particular air tube extensions 104 include a weight 114 at one end allowing it to release air bubbles 110 from a depth in the water beneath lights 30 located above the end of the particular extension 104. Weights 114 can also be applied to outer core 12 of rope 10 to cause the rope 10 to have diminished buoyancy. The addition of weights 114 to rope 10 can be used to place the rope 10 at a desired depth below the surface of the water by increasing the specific density of rope 10.

Buoys 116 can also optionally be applied to various portions of rope 10, such as extensions 104 or outer core 12, in a manner similar to weights 114. Buoys 116 can have the opposite effect of weights 114 by increasing the buoyancy of rope 10 rather than decreasing the buoyancy. The weights 114 and buoys 116 can be constructed as generic weights and buoys commonly known and used in the art. The weights 114 and buoys 116 can further be used in conjunction with air supply tube 100 to selectively adjust the specific density of the rope 10. By adjusting the number of weights 114 and/or buoys 116 attached to rope 10 and the amount of gas 106 and/or liquid contained in air supply tube 100, a user may selectively choose a desired specific density of rope 10.

The weights 114 and buoys 116 can also be used in conjunction with rope 10 for purposes other than buoyancy. The buoys 116 and weights 114 can be constructed and formed to appear as aquatic plant life, such as tree limbs, plants and the like in certain embodiments of the present invention. In such embodiments, buoys 116 and weights 114 can be used in conjunction with air tube extensions 104 and/or electrical extensions 28 to attract fish to a specific area. Buoys 116 can be constructed from any suitable material that enables the appearance of aquatic plant life while maintaining buoyant properties. For example, buoys 116 constructed to appear as tree limbs may be constructed from self-skinning foam or other suitable material having a low specific density that enables buoyancy. Buoys 116 and weights 114 can also be designed and constructed for several other non-fishing uses in conjunction with rope 10. For example, buoys 116 and weights 114 can be designed for use as markers for swimming, or designed for decorative or aesthetic purposes for ponds, streams, aquariums and the like.

Electric rope 10 can also be designed for marking swimming areas, commercial fishing nets, baskets, tow ropes, lift ropes, mechanic ropes, service ropes, obstacles in the water and a variety of other suitable purposes. Electric rope 10 can also be designed for use in automotive repair, on industrial and construction job sites, in connection with mobile multipower and hydraulic units, as decorative lighting, as agricultural lighting or the like.

In one alternative embodiment of the present invention, electric rope 10 can include an air tube 100 while not having buoyant properties. In such an embodiment, the material for outer core 12 and inner core 14 can comprise of any suitable material depending on the desired use. Such materials may include plastics, metals, rubber, and similar materials that have a specific density greater than 1.0. Weights 114 can also be connected to rope 10 to allow rope 10 to function in a non-buoyant manner When rope 10 is designed without buoyant properties, the air tube 100 may still deliver a flow of air 106 through rope 10. Air tube 100 can also be used to release air bubbles 110 beneath the surface of the water or to deliver air, or other gas 106, through water to a desired location. A rope 10 of this embodiment has several potential uses, such as, fishing straight down from a boat, ice fishing, as well as many other non-fishing uses.

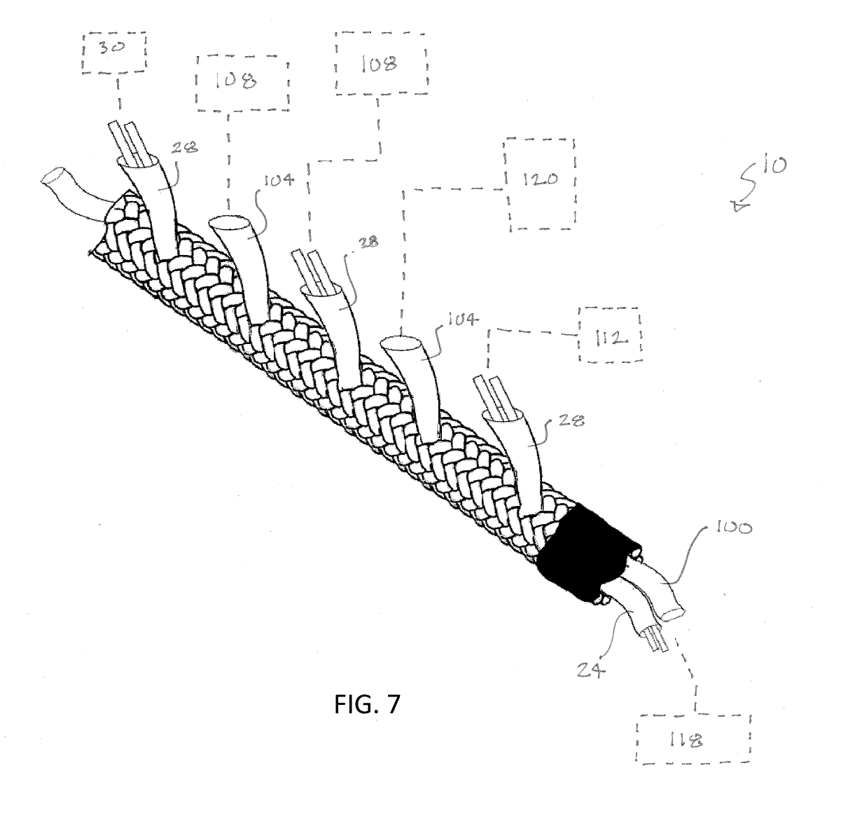

Electric rope 10 can also be used in conditions where buoyancy is not necessary due to the fact that rope 10 is not placed directly in water or other liquid, such as for use in industrial applications, automotive, construction, oil and gas, agriculture, architecture, and the like. In such embodiments, the materials comprising rope 10, including outer core 12 and inner core 14 need not be limited to materials having specific densities less than or about equal to 1.0. In one embodiment, rope 10 can be used in connection with industrial tooling for both pneumatic and hydraulic circuits. In such an embodiment, conductor wire 22 can be used to power an LED light 30 at the end of rope 10, or any intermediate location along rope 10, when rope 10 is attached to an air or hydraulic oil powered tooling 118 as shown in FIG. 7. Air tube 100 can be used to power the tooling 118 by either air or hydraulic oil, or similar manner Rope 10 can also be used to power an LED light 30 at the end of a tire inflator 120, where air tube 100 delivers pressurized air as also illustrated in FIG. 7. Several other similar uses for rope 10 in this embodiment are also anticipated.

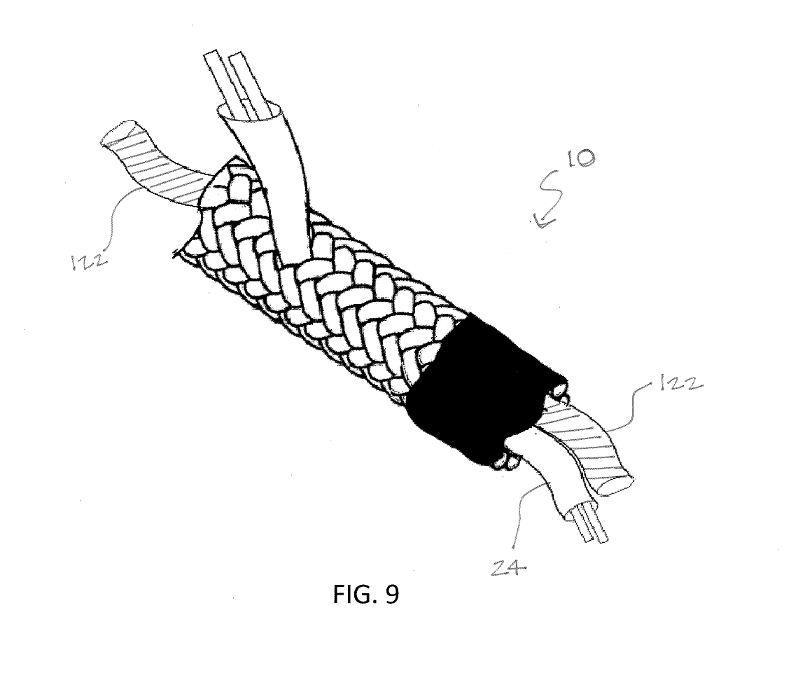

Rope 10 can also be used for decorative lighting and design. In such embodiments, electric rope 10 can include a safety cable 122, such as a steel cable or other suitable material, in conjunction with conducting wire 22 within inner core 14 of rope 10 as shown in FIG. 9. The safety cable 122 can replace the air tube 100 within inner core 14 of rope 10 are be used in addition with air tube 100. Such a design could enable for a single cable system instead of a two cable system where the conductive wire and external safety cable are separated.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A buoyant electric rope comprising:
an inner core comprising a hollow tube suitable for allowing at least one of a gas and a liquid to pass therethrough; and
an outer core comprising a plurality of strands forming a braided rope and defining said inner core;
wherein said rope has a specific gravity approximately less than the specific gravity of water so that said rope to maintain buoyancy in water.

2. The rope of claim 1, wherein said outer core further comprises a coating around at least a portion of said plurality of strands forming said braided rope.

3. The rope of claim 1, wherein said outer core and said inner core are suitable for water use.

4. The rope of claim 1 further comprising at least one extension communicably connected to said hollow tube in said inner core and extending through an opening defined in said outer core.

5. The rope of claim 4, wherein said at least one extension suitable for releasing air bubbles into said water.

6. The rope of claim 5 further comprising an electrically conductive wire positioned in said inner core.

7. The rope of claim 6 further comprising a light connected to said rope and electronically communicable with said conductive wire.

8. The rope of claim 1, wherein said rope is constructed from a plurality of materials, and wherein each material in said plurality of materials has a specific gravity approximately less than or equal to the specific gravity of water.

9. The rope of claim 1, wherein said rope is constructed from a plurality of materials, and wherein a combined specific gravity of said plurality of materials as approximately less than or equal to the specific gravity of water.

10. The rope of claim 1, wherein said plurality of materials includes said gas in said hollow tube.

11. The rope of claim 1 further comprising at least one weight attached to a portion of said rope.

12. The rope of claim 1, further comprising at least one buoy attached to a portion of said rope.

13. An electric rope comprising:
a plurality of rope strands braided to form a braided outer core and defining an interior thereof; and
at least one hollow air tube located within said interior of said braided outer core suitable for allowing a gas to pass therethrough.

14. The rope of claim 13 further comprising at least one extension passing through an opening in said braided outer core, wherein said extension comprises at least one hollow air tube.

15. The rope of claim 13, wherein a collective specific gravity of said hollow braided outer core and said at least one air tube is approximately equal to or less than the specific gravity of water.

16. The rope of claim 13 further comprising a flexible tubing around said outer core for at least a partial length of said rope.

17. The rope of claim 16 further comprising at least one extension passing through an opening in said braided outer core and said flexible tubing, wherein said at least one extension comprises at least one hollow air tube.

18. The rope of claim 17, wherein a collective specific gravity of said braided outer core, said flexible tubing, and said at least one air tube is approximately equal to or less than the specific gravity of water.

19. A buoyant electric rope comprising:
an inner core comprising:
at least one conducting wire;
an insulating sheath placed around said at least one conducting wire; and
a hollow tube suitable for allowing a gas to pass therethrough; and
an outer core comprising:
a plurality of strands forming a braided rope;
wherein a specific gravity of said rope permit said rope to maintain buoyancy in water.

20. The buoyant electric rope of claim 19, wherein an amount of said gas in said hollow tube can be selectively adjusted to affect said specific gravity of said rope to maintain buoyancy in water.
